(19) United States
(12) Patent Application Publication
(10) Pub. No.: US 2011/0295973 A1
(43) Pub. Date: Dec. 1, 2011

(54) INFORMATION PROCESSING SYSTEM, INFORMATION PROCESSING APPARATUS, INFORMATION COMMUNICATION APPARATUS, METHOD, PROGRAM, AND RECORDING MEDIUM

(75) Inventor: Tomonori HABA, Tokyo (JP)

(73) Assignee: CRI MIDDLEWARE CO., LTD., Tokyo (JP)

(21) Appl. No.: 13/116,277

(22) Filed: May 26, 2011

(30) Foreign Application Priority Data
May 27, 2010 (JP) 2010-121499

(51) Int. Cl. G06F 15/16

(52) U.S. Cl. 709/217

(57) ABSTRACT

According to the present invention, an information processing system may be provided and the system comprises an information processing apparatus which registers in a storage apparatus application information such as browsing information of an electric book browsing program or progress information of a game program while making it possible to refer the application information by another information communication apparatus and an information communication apparatus being capable of registering or referring the application information placed on a network.

### TECHNICAL FIELD

The present invention relates to sharing of information used in information communication apparatuses, more particularly relates to an information processing system, an information processing apparatus, an information communication apparatus, a method, program and a recording medium enabling that a plurality of information communication apparatuses may share progress information of an application over the apparatuses.

### BACKGROUND ART

Recently, performances of information communication apparatuses such as mobile phones etc. become higher and higher. Such information communication apparatuses may be possible to browse electronic books and to play game programs and now, particularly mobile information communication apparatuses are paid attention because their mobile performance is superior and is able to browse the electronic books.

As described above, mobile information communication apparatuses, which are able to browse the electronic books, may include such as “iPhone” (Trademark), “iPad” (Trademark) commercially available from Apple Inc., “Kindle” (Trademark) commercially available from Amazon Co. or a mobile information communication apparatus disclosed in Patent Literature 1. As such mobile information communication apparatuses become more and more popular, one user may have a plurality of mobile information communication apparatus.

### PRIOR ART LITERATURE

### [Patent Literature]

[Patent Literature 1] JP 2009-188776

### SUMMARY OF INVENTION

### [Object Addressed by Invention]

The conventional mobile information communication apparatus, however, display settings, browsing progress information, setting information and progress information of game program being set by a user on a particular mobile information communication apparatus are unique information just to the mobile information communication apparatus and then the above described unique information could not be used on other mobile information communication apparatus. That is to say, as plural occupation of the mobile information communication apparatuses with one user becomes popular, it is expected that needs for continuous use of the browsing progress information, setting information or progress information of the game program being set on one mobile information communication apparatus on the other mobile information communication apparatus or a desktop type information communication apparatus may be increased.

The present invention is to address the above objects and the object of the present invention is to provide an information processing system, an information processing apparatus, an information communication apparatus, a method, a program, and a recording medium enabling shared use of the browsing information and/or progress information among a plurality of mobile information communication apparatus and a desktop information communication apparatus.

### [Means for Address to Object]

According to the present invention, an information processing system may be provided and the system may comprise an information processing apparatus which registers in a storage apparatus application information such as browsing information of an electric book browsing program or progress information of a game program while making it possible to refer the application information by another information communication apparatus and an information communication apparatus being capable of registering or referring the application information placed on a network, thereby the present invention may make it possible to share the browsing information and/or the progress information among a plurality of the information communication apparatus.

### BRIEF DESCRIPTION OF DRAWINGS

FIG. 1 shows an application information sharing system 100 of the present embodiment.

FIG. 2 shows an application information manage server 130 and a functional construction 200 of an information communication apparatus 120a according to the present embodiment.

FIG. 3 shows a flowchart of a process of an application information manage server according to the present invention.

FIG. 4 shows a flowchart of a registration process of user information according to the present invention.

FIG. 5 shows a flowchart of an acquisition process of application information according to the present invention.

FIG. 6 shows a flowchart of a registration process of application information according to the present invention.

FIG. 7 shows a data table 700 registered in a user information database 240 of an application information manage server 130 according to the present invention.

FIG. 8 shows a user registration wizard displayed on an information communication apparatus according to the present invention.

FIG. 9 shows an application information acquisition wizard and an application information registration wizard displayed on an information communication apparatus.

### EMBODIMENT PRACTICING INVENTION

Hereafter, the present invention will be described by using embodiments; however, the present invention must not be limited by the embodiments described herein below.

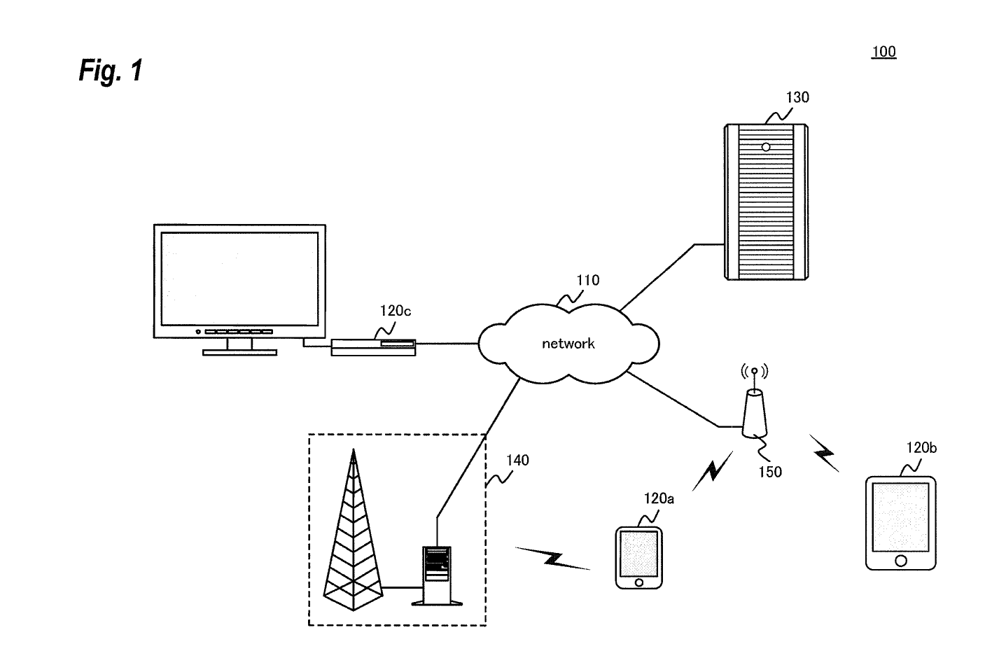

FIG. 1 shows the application information share system 100 of the present invention. The application information share system 100 is a system for processing application information and comprising the network 110, the information communication apparatuses 120a, 120b, 120c, the application information manage server 130, the mobile phone base station 140, and the wireless LAN communication base station 150.

The information communication apparatuses 120a, 120b are mobile information communication apparatus comprising a wireless facility. The information communication apparatus 120a, 120b are able to execute browsing of the electric book, game programs or playback of movie and progress information such as the browsing information of the electric book (for example, a current browsing page, a display magnification, a marking information such as high-light display etc. of the browsing page), progress information of the game program (for example, attribute information such as the progress information of the game stages etc. equipments of the game characters or experience values etc.) or progress information of contents play-backed by a movie playback program (for example, scene numbers, time information etc. for specifying the posed scene); the browsing information or progress information are referred as the application information. The information communication apparatus 120a, 120b transfer the application information to the application information manage server 130 and receive the application information from the application information manage server 130.

The information communication apparatus 120a is a mobile information communication apparatus and is able to make data communications between the application information manage server 130 connected to the mobile phone base station 140 via. the network 110. In the present embodiment, as the information communication apparatus 120a, a mobile phone which is capable of browse of electric books, execution of the game program, or playback of the movie etc. such as iPhone (Trademark) commercially available from Apple Inc. or a mobile information communication apparatus so called as an electric book reader such as Kindle (Trademark) commercially available from Amazon Co. may be adopted.

The information communication apparatus 120b a mobile information communication apparatus which is capable of making the wireless LAN communications 150 such as Wi-Fi (Wireless Fidelity) or Bluetooth (Trademark) etc.; the information communication apparatus 120b is capable of making data communications with the application information manage server 130 connected to the mobile phone base station 140 via. the network 110. In the present embodiment, as the information communication apparatus 120b, a mobile phone which is capable of browse of electric books, execution of the game program, or playback of the movie etc. such as iPhone (Trademark) commercially available from Apple Inc. or a mobile information communication apparatus so called as an electric book reader such as Kindle (Trademark) commercially available from Amazon Co., mobile game machines such as Nintendo DS (Trademark) or Play Station Portable (Trademark) etc. may be adopted.

The information communication apparatus 120c is a desktop game machine which is capable of data communication with the application information manage server 130 via. the network 110. According to the present embodiment, Play Station (Trademark) or Wii (Trademark) etc. as the desktop game machine may be adopted. In other embodiments, the information communication apparatus 120c may have a wireless LAN communication facility such that the apparatus may perform data communication with the application information manage server 130.

The application information manage server 130 is an information processing apparatus for managing the application information of the information communication apparatus. The application information manage server 130 registers users who use the application information sharing system 100 in response to requests for user registration from the information communication apparatuses 120a, 120b, 120c. In addition, the application information manage server 130 provides the application information of the information communication apparatus to the information communication apparatus of the registered user.

The application information manage server 130 may equip a PENTIUM (Trademark) processor or another compatible processor and may execute the program of the present invention described by programming languages such as assembler, C, C++, Java (Trademark), JavaScript (Trademark), PERL, RUBY, PYTHON etc. under control of operating systems such as WINDOWS series (Trademark), MAC (Trademark) OS, UNIX (Trademark) or LINUX (Trademark). Further to the above, the application information manage server 130 comprises RAM for providing executable spaces of the program, a hard disk apparatus (HDD) for storing continuously the program or data and the like thereby realizing each of functional means of the present embodiments on the application information manage server 130 by execution of the present program.

Each of the functional means of the present embodiment may be realized by the apparatus executable program described by the above programming language and the present program may be distributed by string in apparatus readable recording media such as a hard disk apparatus, CD-ROM, MO, a flexible disk, EEPROM, and EPROM etc. or may be transferred through a network as formats which are executable by the other apparatus.

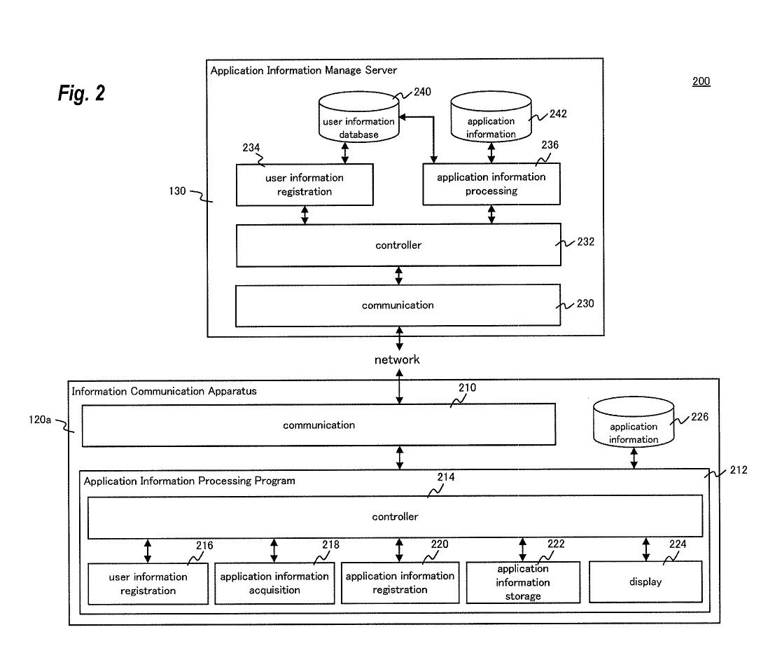

FIG. 2 shows functional construction 200 of the application information manage server of the present embodiment. Hereafter, the functional constructions of the application information manage server 130 and the information communication apparatus 120a will be detailed. Now, the information communication apparatuses 120b, 120c have the same construction with the information communication apparatus 120a and then, detailed description will be omitted.

The information communication apparatus 120a comprises the communication part 210, the application information processing program 212, and the storage apparatus 226. The communication part 210 is the functional means which processes data transferred between the information communication apparatus 120a and the application information manage server 130. The communication part 210 transmits the data received from the application information processing program 212 to the application information manage server 130 and passes the data received from the application information manage server 130 to the application information processing program 212.

The application information processing program 212 is the program for processing the progress information and/or the browsing information used by the high level application programs such as electric book browsing software and game software installed in the information communication apparatus 120a. The application information processing program 212 is the program assembled to the application program and when the application program is started, the program 212 is extended in RAM of the information communication apparatus. The application information processing program 212 comprises the controller part 214 the user information registration part 216, the application information acquisition part 218, the application information registration part 220, the application information storage part 222, and the display part 224.

The controller part 214 is the functional means which controls the entire operations of the application information processing program 212. The controller part 214 invokes the functional means described later in order to perform each processing.

The user information registration part 216 is the functional means which registers the user information to the application information manage server 130. The user information registration part 216 displays an input wizard of the user information on a display and sends a user ID which was input by the user, a password, and a unique identification information (hereafter referred to information communication identifier) to the application information manage server 130. According to the present embodiment, the user ID or the password may be adopted as any letters, numerals and/or any combinations thereof. In addition, an apparatus identification number or a production number of an UIM card may be adopted as the information communication apparatus information.

The application information acquisition part 218 is the function means which acquires the application information from the application information manage server. The application information acquisition part 218 designates the application information to be acquired by using the contents identifier for identifying the contents to be displayed by the higher level application the application identifier for identifying the higher level application. According to the present embodiment, the application information acquisition part 218 may generate the contents identifier only by a name of an electric document which is browsed by the electric book browsing program as the higher level application comprising the application information processing program 212 and a name of the electric document browsing program or the name of the electric book. The application identifier may be generated by using a name of the game program as the higher level application.

The application information registration part 220 is the functional means which makes the registration of the application information to the application information manage server 130. According to the present embodiment, the application information registration part 220 obtains the application information from the storage region for the application information to which the electric document browsing program or the game program assembled the application information processing program 212 refers. The application information registration part 220 may determine the storage region to access with the higher level application by referring to the identifier which indicates a certain storage region in the storage apparatus 226 storing the application information.

When the application information registration part 220 registers the application information to the application information manage server 130, the application information registration part 220 generates the above described contents identifier or the application identifier. Then the application information registration part 220 sends the contents identifier or the application identifier to the application information manage server 130 to register thereof.

In the present embodiment, the application information registration part 220 may register the application information as is which the higher level application registered in the storage apparatus. In the other embodiment, if the application information is the progress information of movies, the application information registration part 220 may register as the progress information the scene time of the scene certain time for example 30 seconds or one minute before the stopped scene or the start time of the chapter including the stopped scene.

Furthermore, the present embodiment may encrypt the application information communicated through the network 110 by various encryption techniques and the application information registration part 220 may transmit the encrypted application information to the application information manage server 130 to register thereof.

The application information storage part 222 is the function al means which the application information obtained from the application information manage server 130 in the storage apparatus 226 of the information communication apparatus. According to the present embodiment, the application information storage part 222 stores the application information received from the application information manage server 130 in the storage region for the application information to which the electric document browsing program or the game program assembled with the application information processing program 212. The application information storage part 222, using the designation information stored in the storage region, may determine the storage region to access. In addition, when the application information received from the application information manage server 130 is encrypted, the application information storage part 222 may decode using various decoding techniques the encrypted application information so as to store thereof in the storage apparatus 226.

The display part 224 is the functional means which displays various input wizard on a display device of the information communication apparatus 120a. According to the present embodiment, data constructing the input wizard may be expanded in RAM of the information communication apparatus upon execution of the application information processing program and the display part 224 may display the input wizard using the above construction data.

The application information manage server 130 may comprise the communication part 230, the controller part 232, the user information registration part 234, the application information processing part 236, the user information database 240, and the storage apparatus 242.

The communication part 230 is the functional means which processes the data communicated between the information communication apparatus 120a and the application information manage server 130. The communication part 230 sends the data received from the controller part 232 to the information communication apparatus 120a and passes the data received from the information communication apparatus 120a to the controller part 232.

The controller part 232 is the functional means which controls the processing of the user information and the application information in the application information manage server 130. The controller part 232 realizes the execution of each process by invoking the functional means described elsewhere in detail.

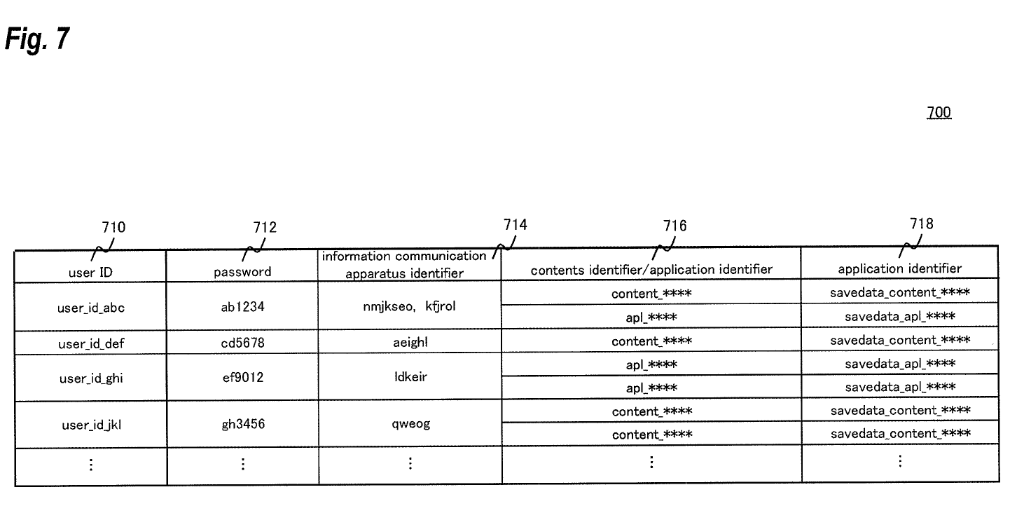

The user information registration part 234 is the functional means which registers the user information received from the information communication apparatus 120a to the user information database 240. The user information registration part 234 registers the received user information to the user information database 240 together with the request for registration upon receiving the request for registration from the information communication apparatus 120a. Now, the user information database will be detailed later by referring FIG. 7.

The application information processing part 236 sends the application information from the storage apparatus 242 to the information communication apparatus 120a in response to request of the information communication apparatus 120a, or registers the application information received from the information communication apparatus 120a to the storage apparatus 242.

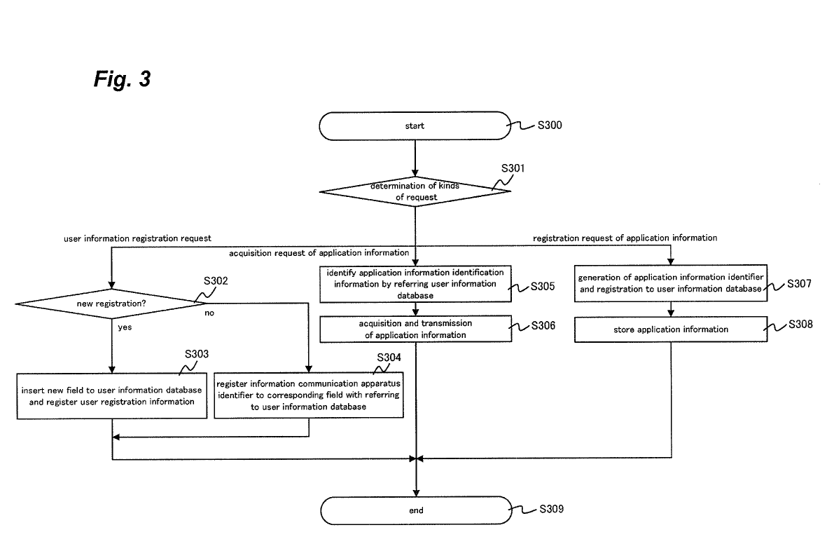

FIG. 3 shows the flowchart of the processing of the application information manage server of the present embodiment. The process of FIG. 3 begins from step S300 upon receiving the request from the information communication apparatus and the controller part 232 determines kinds of the request. When the kind of the request is the request for registration of user information in the determination of the step S301, the process is diverted to the step S302.

In the step S302, the controller part 232 determines that the request for registration is a new registration of the user information and when the request is the request of the new registration (yes), the process is diverted to the step S303. In the present embodiment, the request of the registration of the user information may comprise a request for new registration of the user information and an additional registration request, and the controller part 232 may determine the kinds of the requests using these requests for registration.

In the step S303, the controller part 232 invokes the user information registration part 234, and the user information registration part 234 newly registers the user information received from the information communication apparatus to the user information database 240. On the other hand, the determination that the request is the request for additional registration of the user information has been established in the step S302 (no), the process is diverted to the step S304. In the step S304, the controller part 232 invokes the user information registration part 234 to additionally register the information communication apparatus identifier to an adequate input field of the user information database 240 using the user ID and/or password contained in the user information received from the information communication apparatus and then, the process is terminated at the step S309.

In turn, when the determination in the step S301 determines that the kind of the request is the request for acquisition of the application information, the controller part 232 invokes the application information processing part 236. In the step S305, the application information processing part 236 refers the user information database 240 to specify the application information identifier for the application information to be obtained by using the information communication apparatus identifier received together with the acquisition request of the application information from the information communication apparatus and the application identifier for uniquely identifying the higher level application to which the application information processing program 212 is assembled or the contents identifier for uniquely identifying the contents such as electric books etc. which are browsed by the higher level application. In the step S306, the application information processing part 236 retrieves the application information from the storage apparatus 242 using the specified application information identifier at the step S305 and then sends thereof to the information communication apparatus dispatched the acquisition request and terminates the process at the step S309.

Furthermore, when the determination at the step S301 is done as the kind of the request is the request for registration of the application information, the controller part 232 invokes the application processing part 236. In the step S307, the application information processing part 236 generates the application information identifier using the application identifier or the contents identifier received together with the request for registration from the information communication apparatus and then, relationally registers the information communication apparatus identifier received same time with the request, the application identifier or the contents identifier and the application information identifier in the user information database 240. In the step S308, the application information processing part 236 stores the application information received together with the request for registration in the storage apparatus 242 and terminates the processing at the step S309.

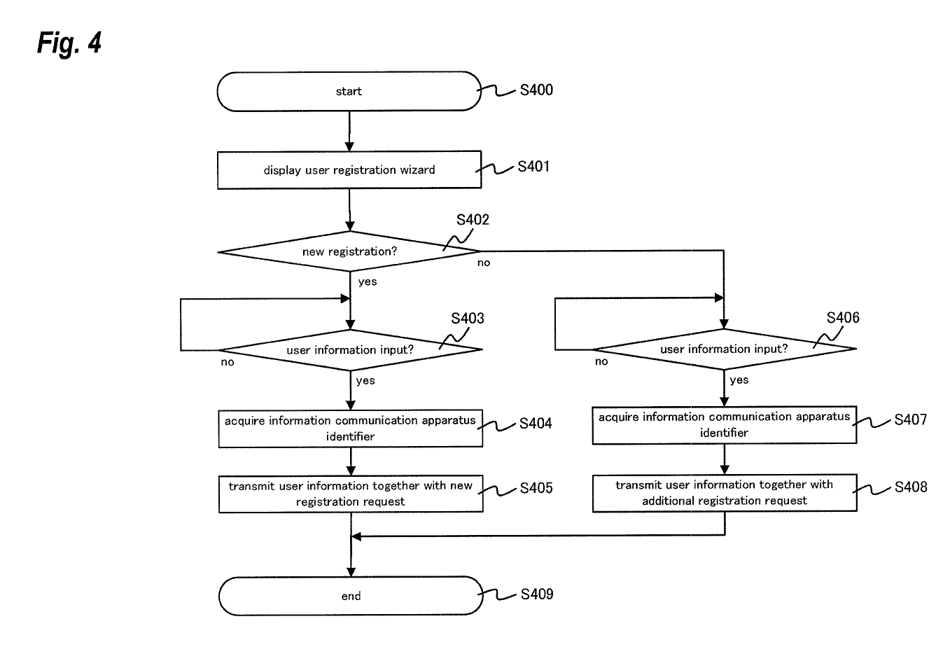

FIG. 4 shows the flowchart of the registration processing of the user information which is executed by the present application information processing program. According to the present embodiment, the process of FIG. 4 may be executed when the higher level application to which the application information processing program 212 is assembled is first invoked by the information communication apparatus. Hereunder, the registration process of the user information will be detailed by referring to FIG. 4.

The process of FIG. 4 begins from the step S400 and in the step S401 the controller part 214 of the application information processing program 212 invokes the user information registration part 216 to display the user registration wizard on the display of the information communication apparatus. In the step S402 the user registration part 216 determines whether or not the request is a new registration request and when the request is the new registration request, the process is diverts to the step S 403.

In the step S403, the user information registration part 216 determines whether or not the user information is input, and if the user information is not input yet (no), the process is reverted to the step S403. On the other hand, the user information is input (yes), the process is diverted to the step S404 such that the user information registration part 216 may acquire the information communication apparatus identifier of the information communication apparatus. In the step S405, the user information registration part 216 sends the user ID, the password input as the user information, and the information communication apparatus identifier together with the request for the new registration to the application information manage server 130 and then terminates the process in the step S409.

On the other hand, the determination in the step S402 is established that the request is the additional registration of the user information (no), the process is diverted to the step S406. In the step S406, the user information registration part 216 determined whether or not the user information is already input, and when not being input (no) the process repeats the step S406. On the other hand, when the user information is input (yes), the process diverts to the step S407 and the user information registration part 216 acquires the information communication identifier of the information communication apparatus. In the step S408, the user information registration part 216 sends the user ID, the password input as the user information, and the information communication apparatus identifier together with the request for the additional registration to the application information manage server 130 and then terminates the process in the step S409.

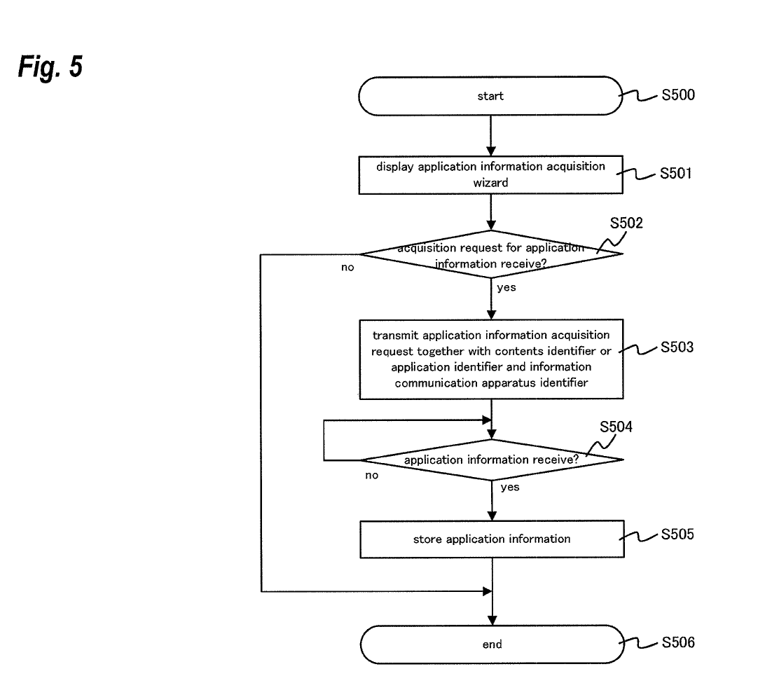

FIG. 5 shows the flowchart of the process for acquiring the application information executed by the present application information processing program. Now, the acquisition process of the application information will be detailed by referring to FIG. 5.

The process of FIG. 5 begins from the step S500 by the invocation of the application information processing program when the higher level application to which the application information processing program 212 is assembled starts. In the step S501, the controller part 214 of the application information processing program 212 invokes the application information acquisition part 218. Thereafter, the application information acquisition part 218 further invokes the display part 224 to display the application information acquisition wizard by the display part 224.

In the step S502, the application information acquisition part 218 determines whether or not the acquisition instruction from the user dispatched by using the application information acquisition wizard. When the instruction for not acquiring the application information is received (no), the process is diverted to the step S506 to end. On the other hand, when the instruction for acquiring the application information is received (yes), the process diverts to the step S503 to end.

In the step S503, the application information acquisition part 218 generates the contents identifier or the application identifier. Then, the application information acquisition part 218 sends the application server 130 the contents identifier or the application identifier and the information communication apparatus identifier together with the acquisition request for the application information. In the step S504, the application information acquisition part 218 determines whether or not the application information is received and when not received (no), the process of the step S504 is repeated. On the other hand, when the application information is received (yes), the process is diverted to the step S505. In the step S505, the application information acquisition part 218 invokes the application information storage part 222 and the application information storage part 222 stores the application information in the storage apparatus 226 and then, the process is terminated at the step S506.

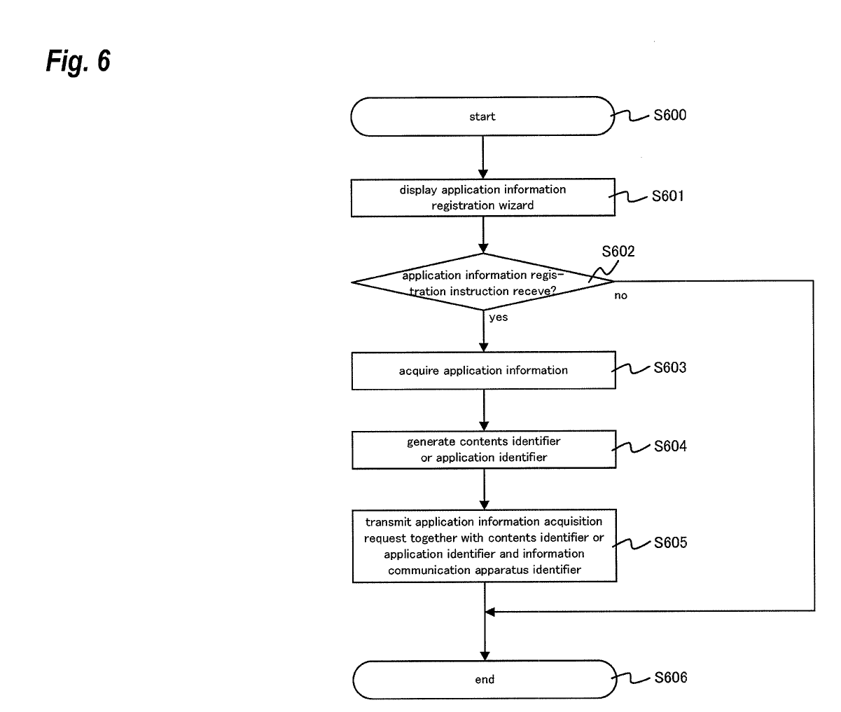

FIG. 6 shows the flowchart of the registration process which is executed by the present application information processing program. Hereunder, the registration process of the application information.

The process of FIG. 6 start from the step S600 with invoking the application information processing program at the termination timing of the higher level application to which the application information processing program 212. In the step S601, the controller part 214 of the application information processing program 212 invokes the application information registration part 220 and furthermore the application information registration part 220 invokes the display part 224 so as to display the application information registration wizard on the display screen of the information communication apparatus.

In the step S602, the application information registration part 220 determines whether or not the registration instruction for the application information dispatched by the user using the application information registration wizard. When the instruction for not registering the application information is received (no), the process is diverted to the step S604 to end. On the other hand, when the instruction for registering the application information is received (yes), the process is diverted to the step S603.

In the step S603, the application information registration part 220 retrieves the application information which the higher level application was stored in the storage apparatus. In the step S604, the application information registration part 220 generates the contents identifier and the application identifier. According to the present embodiment, the contents identifier may be created by using names etc. of the contents which the electric book browsing program as the higher level application has browsed. Alternatively, the application identifier may be created by using names etc. of the game programs as the higher level application.

In the step S605, the contents identifier, or the application identifier, information communication identifier and the application information obtained in the step S603 are sent to the application information manage server 130 and the process is terminated at the step S606.

FIG. 7 shows the data table 700 registered in the user information database 240 of the present application information manage server 130.

In the data table 700, the user ID 710, password 712, information communication identifier 714, contents identifier or the application identification 716, and the application information identifier 718 are relatively registered. In the user ID 710, the user identifier registered by the user registration processing described in FIG. 3 and FIG. 4 are registered. In the embodiment shown in FIG. 7, the language “user_id_abc” etc. are registered as the user ID; however, the user ID may be selected any letter series or numeral series and any combination thereof. In the password 712, the password registered through the user registration processing described with referring to FIG. 3 and FIG. 4 is recorded. According to the embodiment shown in FIG. 7, the letters “abc1234” etc. may be registered; however, any letter series, numeral series, or any combination thereof may be used as the password.

In the information communication apparatus identifier 714, the information communication apparatus identifier received from the information communication apparatus is registered. The information communication identifier 714 may contain a plurality of the identifier about a plurality of the information communication apparatus. According to the present information, the identification numbers such as the unique identification number or the production number stored within UIM card etc. may be used as the information communication apparatus information and any other identifier may be adopted as far as the information communication apparatus may be identified uniquely.

In the contents identifier or the application identifier 716, the contents identifier or the application identifier for identifying the electric book to which the higher level application to which the application information processing program 212 is assembled browses or the contents identifier or the application identifier. According to the present embodiment, the contents identifier may be created by using the names of the electric document to which the higher level application browses and the name of the electric document browsing program by the application information processing program 212. Then, different application information may be acquired or registered for every different electric document browsing program when the user browses the identical contents by the electric document browsing programs in the identical information communication apparatus. In addition, the contents identifier may be generated by using only the name of the electric document, thereby the identical application information may be used in different electric book browsing programs. Furthermore, the application identifier may be generated by using the name of game program which the game program as the higher level application execute.

In the application information identifier 718 the application identifier of the application information registered in the application information manage server 130. As shown in FIG. 7, the application information identifier may be registered in relation to the contents identifier or the application identifier.

According to the present information, a plurality of information communication apparatus identifier may be registered to one user and the application information identifier may be registered in relation to the information communication apparatus identifier, thereby one user may share common application information among different information communication apparatus.

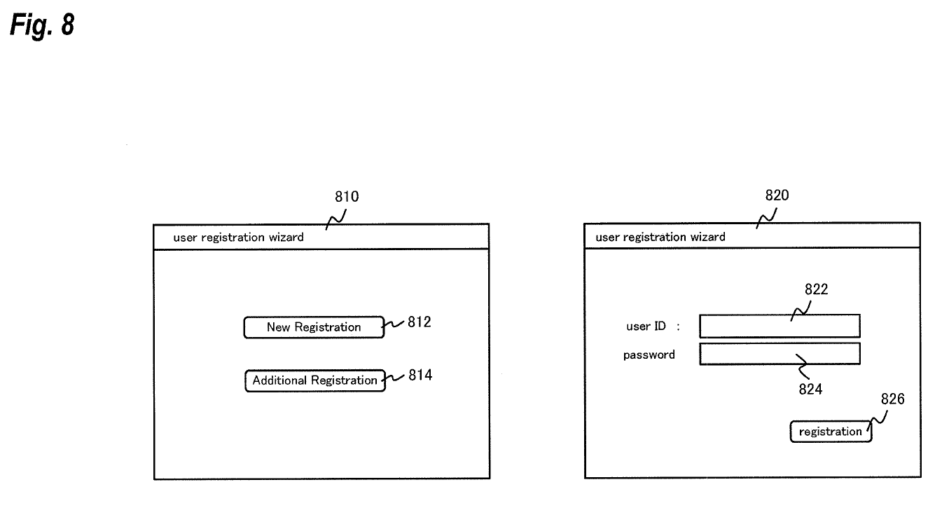

FIG. 8 shows the user registration wizard displayed on the information communication apparatus of the present embodiment. Hereunder, the user registration wizards 810, 820 displayed under the registration processing of the user information described elsewhere with referring to FIG. 4.

The user registration wizard 810 is a GUI for designating the new registration or the additional registration of the user information. The GUI comprises the “New Registration” button 812 which acknowledges the new registration of the user information and the “Additional Registration” button 814 which acknowledges the additional registration of the user information. The “New Registration” button 812 is the button to be clicked when the user first enters the present system. On the other hand, the “Additional Registration” button 814 is the button to be clicked when the user already registered to the present system uses the application information processing program 212 on another information communication apparatus. In the present embodiment, the user registration wizard 820 is displayed when either the “New Registration” button 812 or the “Additional Registration” button 814 is clicked.

The user registration wizard 820 is the GUI for inputting the user information. The user registration wizard 820 displays the box 822, 824 respectively for allowing the input of the user ID and password and the user ID and the password may be transferred to the application information manage server 130 by clicking the “Registration” button 826 after filling the boxes with the user ID and password.

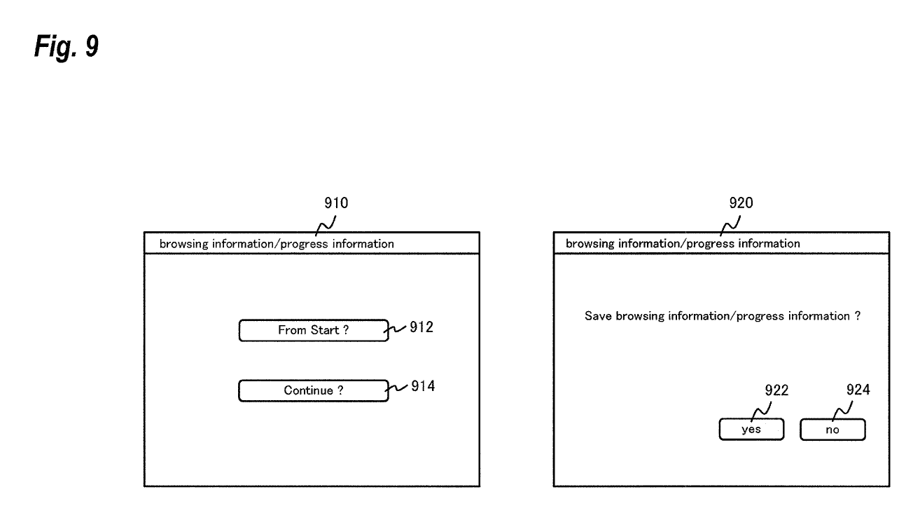

FIG. 9 shows the application information acquisition wizard and the application information registration wizard both being displayed on the present information communication apparatus. Hereunder, the application information acquisition wizard 910 which is displayed in the acquisition process of the application information described with referring to FIG. 5 and the application information registration wizard 920 which is displayed in the registration process of the application information described with referring to FIG. 6 will be detailed.

The application information acquisition wizard 910 is the GUI for instructing whether or not the application information stored in the application information manage server 130 is acquired. The application information acquisition wizard 910 may be displayed upon starting of the higher level application to which the application information processing program is assembled and the application information may be obtained from the application information manage server 130 with clicking the “Continue?” button 914 by the user. On the other hand, when the “From Start?” button 912 is clicked, the application information processing program 212 does not obtain the application information from the application information manage server 130.

The application information registration wizard 920 is the GUI for instructing whether or not the application information should be registered to the application information manage server 130. The application information registration wizard 920 may be displayed upon termination of the higher level application to which the application information processing program is assembled, and in response to the user's click of the “yes” button 922, the application information may be registered to the application information manage server 130. On the other hand, when the “no” button 924 is clicked, the application information processing program 212 does not make registration of the application information to the application information manage server 130.

Hereinabove, the present embodiments have been explained; however, the present invention must not be limited to the above embodiments. There may be other embodiments, additions, changes, deletions which are made by a person skilled in the art maybe allowed to the present invention and any embodiments which provide work and technical advantage of the present invention may be included in the scope of the present invention.

### BRIEF DESCRIPTION OF NUMERALS

100—application information manage system,

110—network,

120a,120b,120c—information communication apparatus,

130—application information manage server,

140—mobile phone base station,

150—wireless LAN communication base station

1. An information communication apparatus comprising:
a registration part which acquires application information used by an application installed in the information communication apparatus;
an acquisition part which acquires application information of another information communication apparatus registered in the information processing apparatus; and
a storage part which registers the acquired application information to a storage part of the information communication apparatus so as to make it possible to available with the application.

2. The information communication apparatus of claim 1,
wherein the registration part registers in the information processing apparatus the application information in relation to identifier of the information communication apparatus, identifier of the application, or identifier of contents used by the application and
the acquisition part obtains the application information by using the identifier of the application information or the identifier of the contents.

3. The information communication apparatus of claim 1, wherein the application information is selected from the group consisting of browsing information of an electric book browsing program, progress information of a game and/or a movie play-back application which are executed by the information communication apparatus.

4. The information communication apparatus of claim 1, wherein the information communication apparatus is a mobile information communication apparatus which is capable of browsing of the electric book, executing the game program and/or playing back of the movie.

5. The information communication apparatus of claim 1, wherein the information communication apparatus is a desktop type game machine or a mobile type game machine.

6. The information processing system comprising a plurality of information communication apparatuses and an information processing apparatus being capable of data communications with the information communication apparatuses, the information communication apparatus comprising:
a registration part which acquires application information used by an application installed in the information communication apparatus;
an acquisition part which acquires application information of another information communication apparatus registered in the information processing apparatus; and
a storage part which registers the acquired application information to a storage part of the information communication apparatus so as to make it possible to available with the application.

7. A method executed by an information communication apparatus which is capable of data communications, the method making the information communication apparatus execute the steps of:
registering application information used by an application installed in the information communication apparatus;
acquiring application information of another information communication apparatus registered in the information processing apparatus; and
storing the acquired application information to a storage part of the information communication apparatus so as to make it possible to available with the application.

8. The method of claim 7, wherein the step of registering application information comprising the step of;
registering in the information processing apparatus the application information in relation to identifier of the information communication apparatus, identifier of the application, or identifier of contents used by the application and
the acquiring application information comprises the step of;
obtaining the application information by using the identifier of the application information or the identifier of the contents.

9. The method of claim 7, wherein the application information is selected from the group consisting of browsing information of an electric book browsing program, progress information of a game and/or a movie play-back application which are executed by the information communication apparatus.

10. A program for making execute an information communication apparatus the steps of:
registering application information used by an application installed in the information communication apparatus;
acquiring application information of another information communication apparatus registered in the information processing apparatus; and
storing the acquired application information to a storage part of the information communication apparatus so as to make it possible to available with the application.

11. The program of claim 10, wherein the step of registering application information comprising the step of;
registering in the information processing apparatus the application information in relation to identifier of the information communication apparatus, identifier of the application, or identifier of contents used by the application and
the acquiring application information comprises the step of;
obtaining the application information by using the identifier of the application information or the identifier of the contents.

12. The program of claim 10, wherein the application information is selected from the group consisting of browsing information of an electric book browsing program, progress information of a game and/or a movie play-back application which are executed by the information communication apparatus.

13. An apparatus readable medium recording a program for making execute an information communication apparatus the steps of:
registering application information used by an application installed in the information communication apparatus;
acquiring application information of another information communication apparatus registered in the information processing apparatus; and
storing the acquired application information to a storage part of the information communication apparatus so as to make it possible to available with the application.

14. The apparatus readable medium of claim 13, wherein the step of registering application information comprising the step of;
registering in the information processing apparatus the application information in relation to identifier of the information communication apparatus, identifier of the application, or identifier of contents used by the application and
the acquiring application information comprises the step of;
obtaining the application information by using the identifier of the application information or the identifier of the contents.

15. The apparatus readable medium of claim 13, wherein the application information is selected from the group consisting of browsing information of an electric book browsing program, progress information of a game and/or a movie play-back application which are executed by the information communication apparatus.
